(19) United States
(12) Patent Application Publication
(10) Pub. No.: US 2013/0120199 A1
(43) Pub. Date: May 16, 2013

(54) VAULT ANTENNA FOR WLAN OR CELLULAR APPLICATION

(71) Applicants: PETER FRANK, Stittsville (CA); ROLAND A. SMITH, Nepean (CA); DAVE PELL, Carp (CA); STEPHEN RAYMENT, Ottawa (CA); ALAIN J. BRAZEAU, Stittsville (CA); TRIET LE, Kanata (CA)

(72) Inventors: PETER FRANK, Stittsville (CA); ROLAND A. SMITH, Nepean (CA); DAVE PELL, Carp (CA); STEPHEN RAYMENT, Ottawa (CA); ALAIN J. BRAZEAU, Stittsville (CA); TRIET LE, Kanata (CA)

(73) Assignee: ERICSSON CANADA, Ottawa (CA)

(21) Appl. No.: 13/609,971

(22) Filed: Sep. 11, 2012

Related U.S. Application Data
(63) Continuation-in-part of application No. 12/870,259, filed on Aug. 27, 2010.
(60) Provisional application No. 61/237,822, filed on Aug. 28, 2009.

(51) Int. Cl. H01Q 19/10

(52) U.S. Cl. CPC H01Q 19/10
USPC 343/719; 343/834

(57) ABSTRACT

A fringe-effect antenna module includes coupling structure configured to couple the module to a communications vault that is disposed substantially at ground level. A support structure (which preferably includes an electronics unit) is coupled to the coupling structure, and at least one antenna element is coupled to the support structure. A metallic deflector is coupled to at least one of (i) the coupling structure and (ii) the support structure. The metallic deflector has an edge that is positioned substantially parallel to the ground so as to cause a fringe effect upon the RF signals of the antenna to cause those RF signals to bend in a direction toward the ground.

This is a continuation-in-part of U.S. patent application Ser. No. 12/870,259, filed Aug. 27, 2010 which is a non-provisional of U.S. Patent Appln. No. 61/237,822, filed Aug. 28, 2009, the entire contents of all which are incorporated herein by reference.

### BACKGROUND OF THE INVENTION

### Field of the Invention

The present invention provides an innovative antenna system for underground vaults. It addresses the important requirement of ground level azimuth coverage, while providing the means to achieve elevation coverage as required. It also addresses the means of mass producing low cost antenna solutions for widespread microcell deployments while addressing the technical issues associated with underground vaults.

Ground level vaults are widely employed by service providers such as cable television providers, or telephone providers, to access buried plant equipment and cable. These vaults are typically positioned to be flush with the ground level, and are found throughout metropolitan areas where cable or telecom equipment is located.

With the proliferation of wireless local area networks or WLANs, there has been an increase in requirements to find cost effective means to deploy access points using various “assets” available to service providers. One key asset which many service providers have in abundance is underground vaults.

The present invention provides a means of providing repeatable and optimized radio frequency (RF) coverage using vaults as the source of the radiating element. As is well known in the industry, good RF coverage usually relies on antennas to be mounted at high elevations, such as on a pole or roof top. Most cities have hundreds or thousands of cell towers or roof top “macro-cells” consisting of high powered transmitters of 40 W-per-radio channel with large high gain antennas. These macro-cells provide cellular coverage extending hundreds to thousands of meters. Many radio propagation models are published detailing the empirical tradeoff of antenna height with respect to cellular coverage. This is a well known and documented science.

As the cellular revolution has progressed, and the number of cellular users has grown, more cost effective lower power (i.e., up to 4 W) base stations have been introduced to provide smaller cellular coverage zones of a few hundred meters. Mounting of equipment on light poles, and street level assets such as bulletin boards or building walls, have become a cost effective means of achieving cellular underlay networks, used to offload the capacity of the macro-cellular network. Cell coverage areas of less than a few hundred meters have not been considered, in part due to the high costs of the microcells, but also due to the high leasing cost of the mounting assets.

The cellular revolution has progressed with the introduction of “pico-cells” and “nano-cells”; however, neither of these two types of base stations has been used in any significant way for outdoor cellular coverage. Pico-cellular base stations have not yet found a practical use in the industry. However, nano-cell base stations have successfully found a significant market penetration for indoor residential applications.

Wireless LAN systems have risen as a disruptive technology to cellular systems. WLAN systems employ unlicensed spectrum and offer data throughput levels which are two orders of magnitude higher than commercially deployed cellular systems. WLAN systems also have lower transmitter power (i.e., typically less than 4 W EIRP) and operate in an uncontrolled unlicensed spectrum and cannot readily be deployed using macro cells roof tops or cell towers. Outdoor WLAN systems have typically been deployed by attaching the WLAN transceivers to street light poles or handing these transceivers on cable plant in the same fashion that cable amplifiers or DSL repeaters are deployed and powered. These WLAN systems typically provide coverage radii of hundreds of meters. Smaller cells have been deployed inside specific venues such as Starbucks or McDonald's. These coverage areas are very small—having radii in the range of tens of meters up to one hundred meters, but cost effective due to the low equipment costs of the WLAN transceivers.

Many venues have been found which had no above ground assets upon which to place a WLAN transceiver. These venues include communities with no aerial plant or above-ground power or communications poles. In some areas, poles may exist, but municipal regulations prohibit the deployment of equipment on the poles, as a regulation to minimize visible clutter. In all of these areas, the same services are typically carried, but are buried and carried through under ground conduits, accessible only at pedestals, metal service cabinets, or at ground level vault locations. Accordingly, the present invention addresses this shortcoming.

### SUMMARY OF THE INVENTION

In one aspect, the invention provides a fringe-effect antenna module having coupling structure configured to couple the module to a communications vault disposed substantially at ground level. A support structure is coupled to the coupling structure, and at least one antenna element is coupled to the support structure. A metallic deflector is coupled to at least one of (i) the coupling structure and (ii) the support structure. The metallic deflector has an edge, which is positioned substantially parallel to the ground. The metallic deflector and the edge are configured to cause a fringe effect upon the RF signals of the antenna to cause the RF signals to bend in a direction toward the ground.

Preferably, the metallic deflector comprises an upside-down, frusto-rectangular shape having four sloped sides.

The fringe-effect vault antenna may further include a bell jar cover attached to the vault cover, the bell jar being configured to maintain an air pocket around the at least one antenna element. A radome may be mounted beneath the bell jar cover.

The fringe-effect vault antenna may be selected from the group consisting of an omni-directional fringe-effect vault antenna, a directional fringe-effect vault antenna, a parabolic fringe-effect vault antenna, and a corner reflecting fringe-effect vault antenna.

In another aspect, the invention a vault antenna module having a support structure including electronic circuitry. Coupling structure is coupled to the support structure and is configured to couple to a substantially ground-level vault. An antenna element is coupled to the support structure. A deflector plate has at least one edge that is configured to bend RF signals to/from the antenna element in a direction substantially along the ground. A cable connector is coupled to the support structure.

In yet another aspect, the invention provides a method of propagating RF signals to/from a substantially ground-level vault having an antenna element below ground level. A support structure is coupled into the substantially ground-level vault, and a sloped deflector, coupled to the support structure, is disposed to intersect a main beam of the antenna element. An edge of the deflector is disposed to cause a fringe effect on the RF signals of the antenna element to bend the RF signals in a direction toward the ground level.

The means of wired connectivity coupled into the module may be selected from the group consisting of DOCSIS, DSL, ADSL, HDSL, VDSL, EPON, GPON, Optical Ethernet, T1, and E1. The at least one antenna element may be configured to enable wide-band multi-carrier operation. The at least one wireless transceiver may include a plurality of wireless transceivers, and the at least one antenna element may include a plurality of antenna elements, each of the plurality of antenna elements corresponding to a different one of the plurality of wireless transceivers.

### BRIEF DESCRIPTION OF THE DRAWINGS

FIG. 1 illustrates several vault antenna locations used for simulations.

FIG. 2 shows a graph of simulated vault antenna gains for the locations illustrated in FIG. 1.

FIG. 3 illustrates several vault antenna angles used for simulations.

FIG. 4 shows a graph of simulated vault antenna gains for the angles illustrated in FIG. 3.

FIG. 5 illustrates several vault antenna locations together with a metal reflector for causing a fringe-effect according to a preferred embodiment of the present invention, as used for simulations.

FIG. 6 shows a graph of simulated vault antenna gains for the locations and fringe effects illustrated in FIG. 5.

FIG. 7 illustrates a vault antenna configuration with a flat metal plate used as a reflector for causing a fringe-effect according to a preferred embodiment of the present invention.

FIG. 8 shows a graph of simulated vault antenna gains for the antenna configuration illustrated in FIG. 7.

FIG. 9 illustrates several vault antenna tilt configurations for simulations.

FIG. 10 shows a vault.

FIG. 11 shows the vault of FIG. 10 with the cover removed, thereby exposing an omni-directional vault antenna.

FIG. 12 shows an omni-directional vault antenna according to a preferred embodiment of the present invention.

FIG. 13 shows a vault.

FIG. 14 shows the vault of FIG. 13 with the cover removed, thereby exposing a directional vault antenna according to a preferred embodiment of the present invention.

FIG. 15 shows a perspective view of a lengthwise directional vault antenna according to a preferred embodiment of the present invention.

FIG. 16 shows a profile view of a lengthwise directional vault antenna according to a preferred embodiment of the present invention.

FIG. 17 shows a perspective view of a width-wise directional vault antenna according to a preferred embodiment of the present invention.

FIG. 18 shows a profile view of a width-wise directional vault antenna according to a preferred embodiment of the present invention.

FIG. 19 shows a perspective view of a vault.

FIG. 20 shows a perspective view of the vault of FIG. 19 with the cover removed, thereby exposing a directional vault antenna according to a preferred embodiment of the present invention.

FIG. 21 shows a perspective view of the directional vault antenna of FIG. 20 according to a preferred embodiment of the present invention.

FIG. 22 shows a profile view of the directional vault antenna of

FIG. 20 according to a preferred embodiment of the present invention.

FIG. 23 shows a profile view of width-wise directional vault antennas with the deflectors having parabolic and corner reflector profiles.

FIG. 24 shows a perspective view of a fringe-effect antenna module according to the present invention, showing the bell-jar covering.

FIG. 25 shows a perspective view of the FIG. 24 embodiment, showing the radome and the bottom of the electronics module, which are preferably disposed under the bell-jar covering.

FIG. 26 shows a perspective view of a fringe-effect antenna module according to the present invention installed in a third-party vault.

FIG. 27 shows a top view of the FIG. 26 embodiment.

FIG. 28 is a perspective, close-up view of the FIG. 26 embodiment.

FIGS. 29a and 29b are, respectively, end and side views of a further embodiment according to the present invention.

FIG. 30 is a perspective view of the FIGS. 29a and 29b embodiment.

### DETAILED DESCRIPTION OF THE INVENTION

WLAN solutions have been deployed inside above ground pedestals and in above-ground cabinets. These solutions maximize cell coverage, achieving reaches of 150 m-300 m depending on ground level clutter. Advanced multiple input-multiple output (MIMO) radio features and antennas can extend this coverage; and deployment redundancy is the main means used to ensure that clients using these systems are rarely affected by ground level propagation impairments.

The present invention addresses the specific aspect of ground level vaults as a means of providing WLAN coverage. These vaults have not typically been used in the cellular industry for outdoor coverage, and hence there has been no available literature or science developed for optimal radio or antenna solutions. The key issue associated with using ground level vaults is the ability to provide ground level coverage—that is, the ability to provide acceptable antenna gain along the street so that pedestrians and local businesses will see radio coverage from the vault.

To tackle this problem, simulation tools have been used to simulate a variety of antenna solutions which could be readily deployed in the vault. The goal has been to achieve a coverage radius of greater than 100 meters of street level coverage from a single vault, so that specific venues could be covered in a cost-effective manner using a few wireless transceivers. In a preferred embodiment, these transceivers employ DOCSIS 2.0 backhaul for connection to the Internet, and are plant-powered from 40-90 VAC supplied over the main feeder networks of the cable service providers. However, in an alternative embodiment, this system could employ DOCSIS 3.0, DSL, VDSL, HDSL or other means connected to the Internet, and could employ standard AC powering such as 100-240 VAC, or higher voltage AC power such as 277, 374, 480, or 600 VAC, or even pair-powered via ±137 VDC or ±180 VDC or other suitable power.

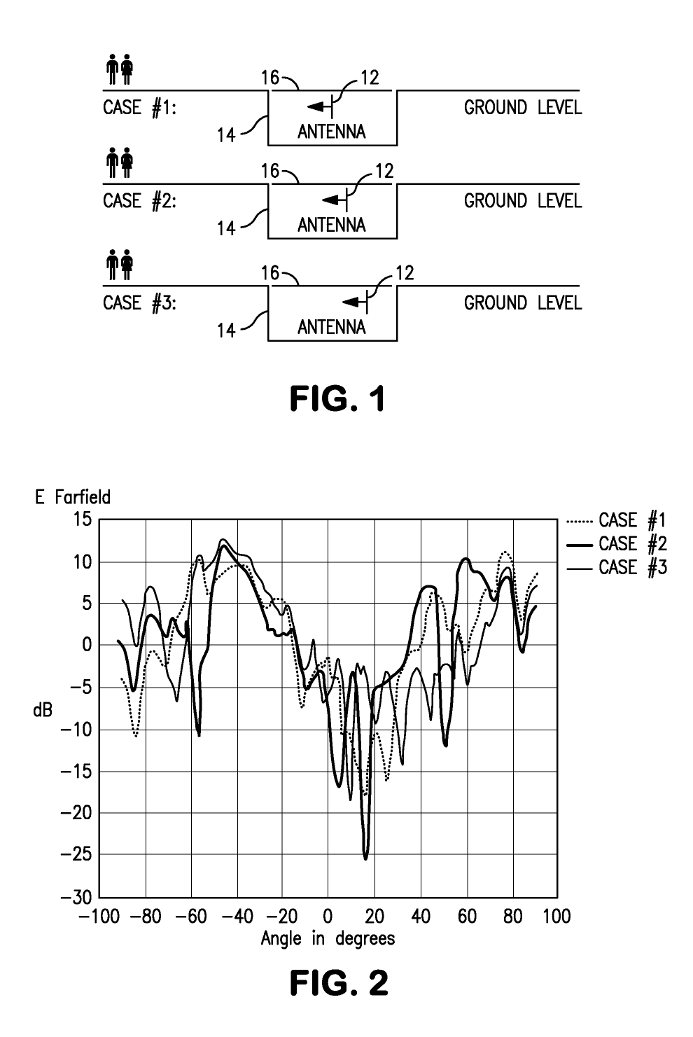

The simulations all showed that ground level vault deployments suffered from poor gain at street level. For example, referring to FIGS. 1 and 2, when an 8 dBi antenna 12 was located in an underground vault 14 with a plastic cover 16, the antenna 12, even when located at different positions, provided poor gain at ground level (“Angle in Degrees=−90”), ranging from 0 dBi to much lower. These simulation results agreed with earlier field measurements demonstrating poor RF coverage when an antenna is placed inside a vault. The field results show a best case reach of 50 meters and having a poorly controlled azimuth pattern. In all of these cases, RF reach was established to be at the −75 dBm threshold at the client device.

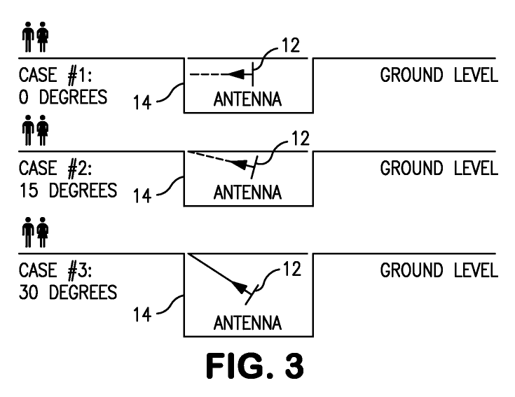

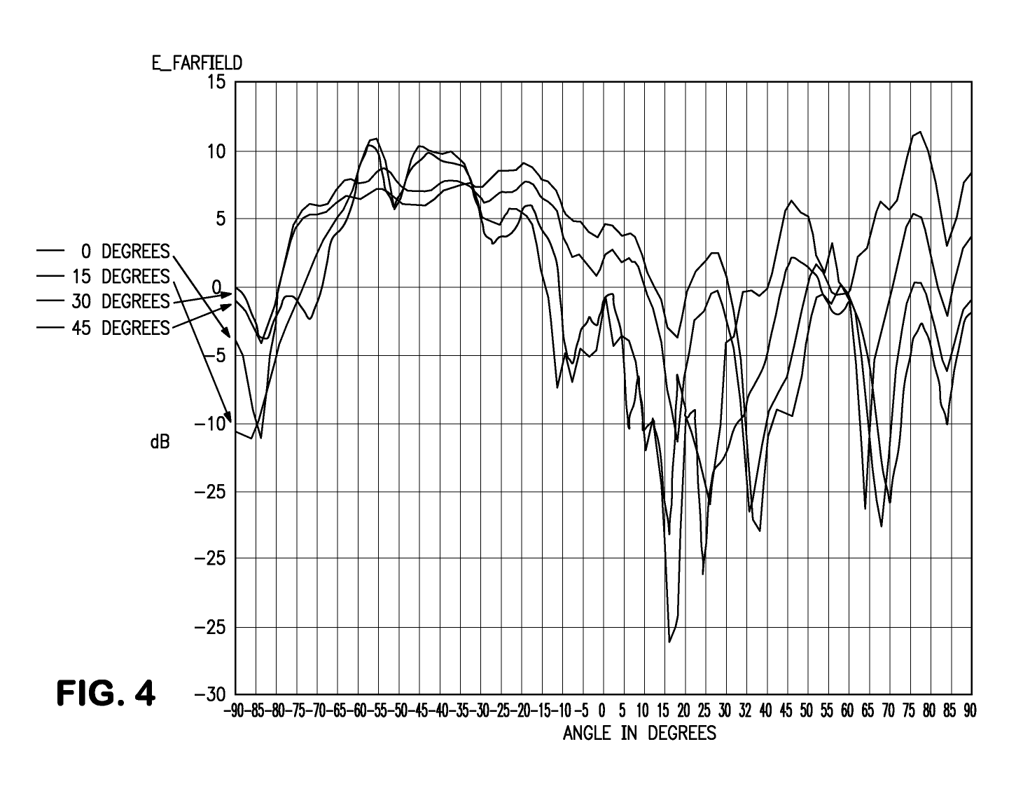

Multiple additional simulations were also conducted. In the additional simulations, several aspects of the vault antenna system were varied—for example, referring to FIGS. 3 and 4, the position and angle of the antenna 12, and changing the gain of the antenna 12—were varied in an attempt to improve the gain of the vault antenna system. However, none were entirely successful. In all cases, the gain of the antenna 12 into the sky was very good, but along the street level was highly variable, but usually quite poor. In addition, detailed simulations for studying the current flow of the electrical charge have verified that none of the simulations showed acceptable current flow at ground level, which would achieve the desired result of a high gain antenna at street level.

In outdoor deployments, RF signals can “fringe” or edge-diffract around buildings. In electromagnetic wave propagation, edge diffraction (or the knife-edge effect) is a redirection by diffraction of a portion of the incident radiation that strikes a well-defined obstacle. The knife-edge effect is explained by Huygens-Fresnel principle, which states that a well-defined obstruction to an electromagnetic wave acts as a secondary source, and creates a new wavefront. This new wavefront propagates into the geometric shadow area of the obstacle. The term “fringe-effect” is used herein to describe edge diffraction or the knife-edge effect.

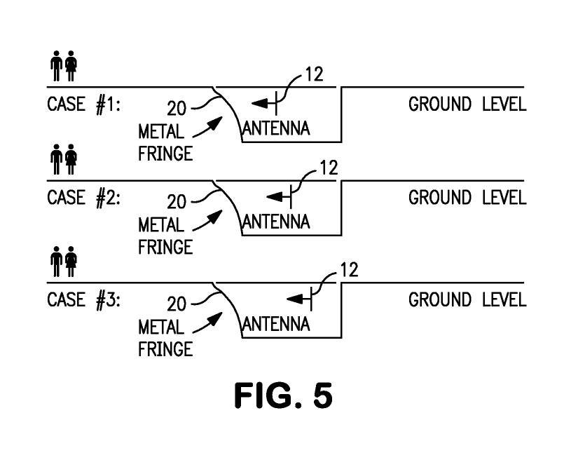

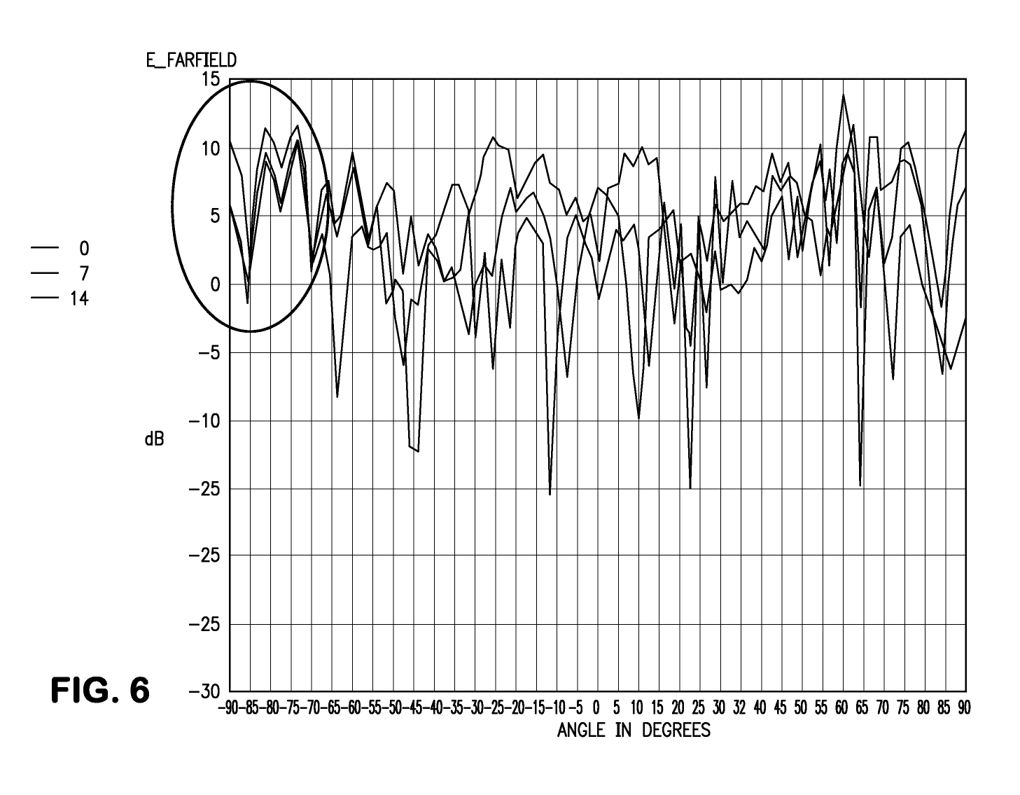

The design of a “fringe effect” into the vault antenna—i.e., a metallic edge for causing the radio signals from the antenna to “diffract” toward the ground—has also been modeled and simulated by the present inventors. The initial results have been promising, showing a consistent and repeatable antenna gain along the horizon/street level. These results are shown in FIGS. 5 and 6, in which the antenna 12 is illustrated as facing a curved sheet of metal 20 used to cause the fringing effect. The area of acceptable street level gain is highlighted in FIG. 6. As can be seen, the gain is consistent and repeatable.

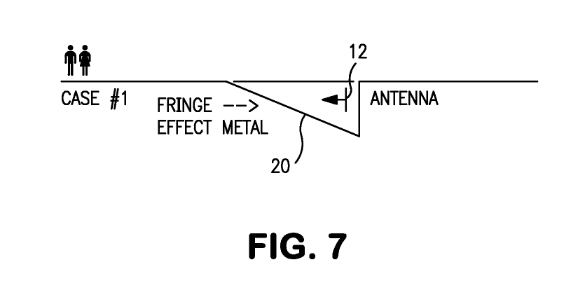

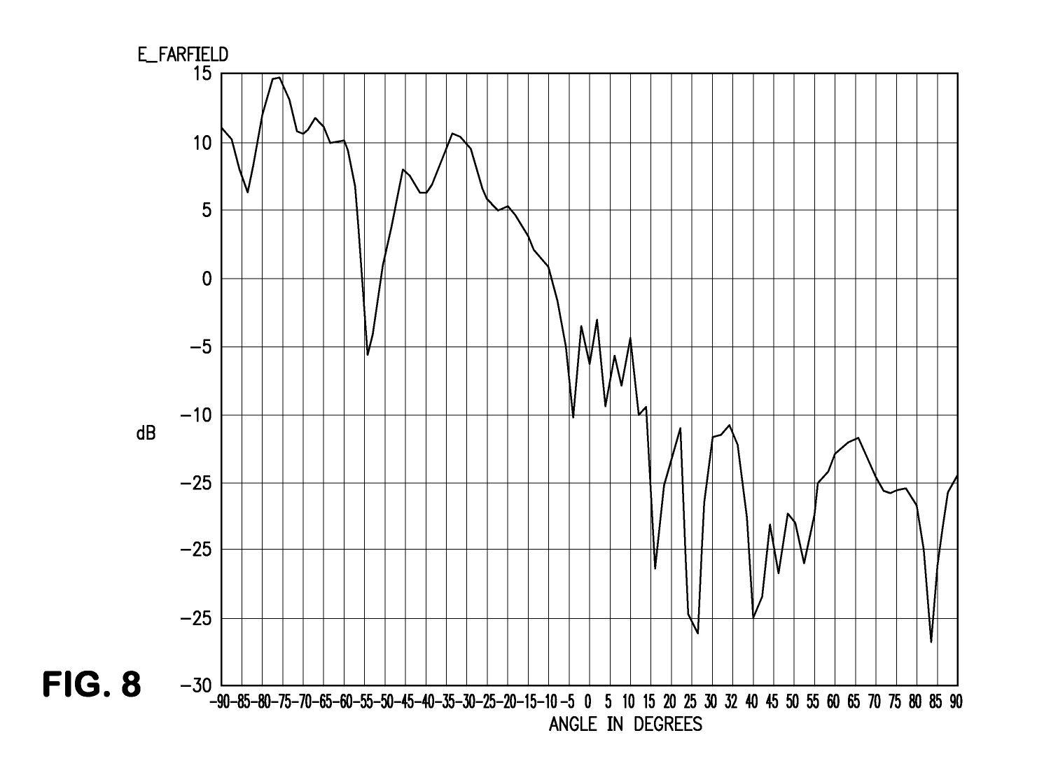

Additional simulations have been performed to test variations of metallic edges, and also to test antenna orientations to determine an optimal fringe effect antenna design for vaults. Referring to FIGS. 7 and 8, the results of these additional simulations have been very promising, with gains as high as 12 dBi along the horizon, and with good azimuth coverage from an 8 dBi antenna.

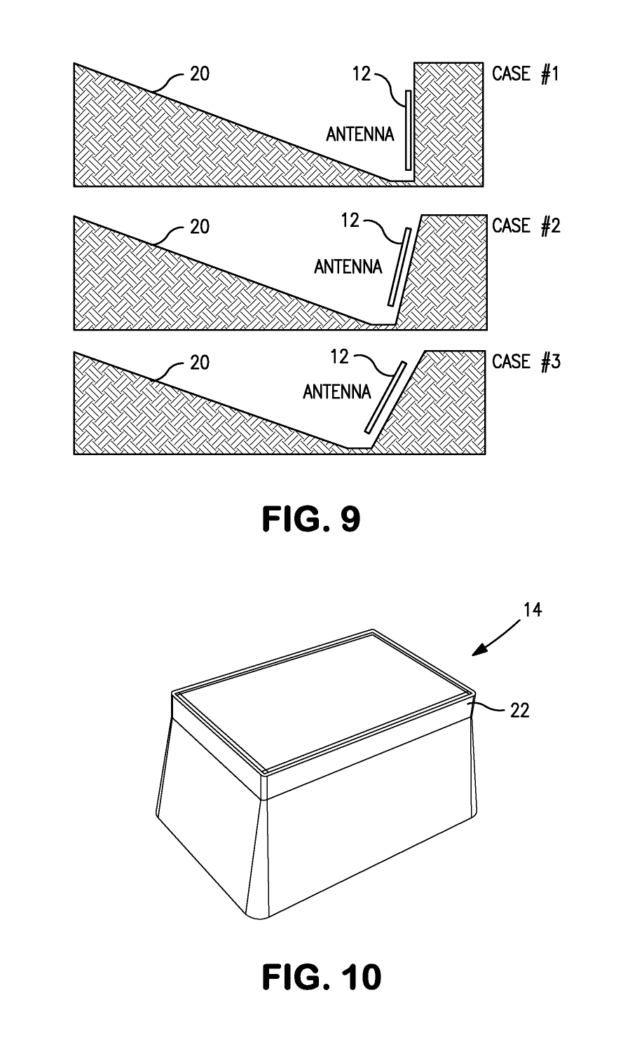

Further simulations have been conducted to attempt to optimize the antenna tilt and relative position in the vault antenna bracket to determine optimal tilts. Referring to FIG. 9, three antenna tilt cases are illustrated; however, multiple variations have been verified.

In this manner, an innovative antenna system according to a preferred embodiments of the present invention has been designed and field-tested to verify functional operation. The description below explains the important fringe effects which are utilized and the means by which they are incorporated into a vault antenna according to a preferred embodiment of the present invention. Moreover, the present invention provides important aspects of the fringe effect vault antenna, including details of the mounting bracket, such as the relative location and tilt of the antenna element. Protective measures to ensure that a vault antenna operates correctly under adverse weather conditions which would result in flooding of the vault are also described. The present invention may be implemented by using different types of vault covers from different manufacturers, such as plastic vault covers manufactured by Pencell or concrete vault covers manufactured by NewBasis. Potential variations of the vault antenna, which allow for different orientations of vaults and different directional and omni-directional antenna solutions for coverage, are also described. Elevation directed antennas for building coverage are also disclosed. MIMO vault antennas are also disclosed.

With the evolution of the wireless industry to smaller cells utilizing the widely available asset of vaults, it is anticipated that vaults will become important, not only for WLAN-IEEE 802.11bgn and IEEE 802.11an coverage, but also for next generation cellular systems such as IEEE 802.16e, “LTE” or Long Term Evolution, or other such cellular standards.

There are at least two preferred embodiments of the vault antenna according to the present invention: the omni vault antenna and the directional vault antenna. Both preferred embodiments are intended for street coverage, although the directional vault antenna has multiple variations which enable coverage of tall buildings as well as street level coverage. These two embodiments are described below. Alternative embodiments of the present invention include parabolic and corner reflector vault antennas, which are similar to the directional vault antenna, but for which the shape of the deflector bracket is either parabolic or V-shaped as a corner reflector. FIG. 23 shows the cross-section of how the deflector metal can be shaped to be a corner reflector or parabolic reflector. An antenna 36 is directed towards the deflector/reflector 42, whose radiated fields are then reflected towards the fringe-edge 26. An objective of these alternative embodiments of the present invention is to achieve both very high gain directional coverage of tall buildings by pointing the parabolic or corner reflector antenna with one or more antenna elements (for MIMO) at the building upper floors, while achieving a ground level fringe effect coverage for street level coverage. While most vaults will be at least partially below ground level (where the vault cover is slightly under ground), other implementations are contemplated where the cover is at ground level, or slightly above ground level. All such implementations are referred to as “substantially at ground level.”

In a preferred embodiment of the invention, the desired fringe-effect may be optimized by ensuring that the metal fringe completely covers the entire beamwidth of the signal azimuth for the received signal. The curvature of the metal fringe may vary from a completely flat fringe, as illustrated in FIG. 7, to any degree of curvature, as illustrated, for example, in FIG. 5. Regarding tilt, the tilt may be varied, as shown in FIG. 9. Experimental results have shown that the tilt is optimized (i.e., peak antenna gain is achieved) when the boresight of the antenna is aligned with the direction of the signal beam. These results also show that the orientation of the metal fringe is optimized when the horizontal aspect of the signal beam is aligned with the metal fringe edge.

OMNI VAULT ANTENNA. The omni vault antenna provides an effective means of omni-directional coverage of a street or open venue. This antenna is located in a ground level vault (where the top of the vault is at ground level, or slightly thereabove or therebelow; and the antenna is below ground level) and includes one or more omni-directional antennas mounted in a bracket which slopes upwards to the edge of the vault. Referring to FIG. 10, a vault 14 is typically at least partially (often completely) buried in the ground—either in a street, or in a sidewalk, or in soil. The vault 14 is typically made of concrete or high strength plastic. Referring to FIG. 11, the vault 14 of FIG. 10 is shown with the lid or cover 22 removed. Circuitry typically contained within such vaults is not show in the drawings, for clarity. The vault antenna structure is shown and includes an omni antenna 12 in the center section of the vault 14, with a supporting metallic bracket 24 which slopes upward from the antenna element to guide the antenna signals upward and toward the edge 26 of the vault 14. The fringe effect is realized when the RF signals transitions across the top edge 26 of the metallic bracket 24.

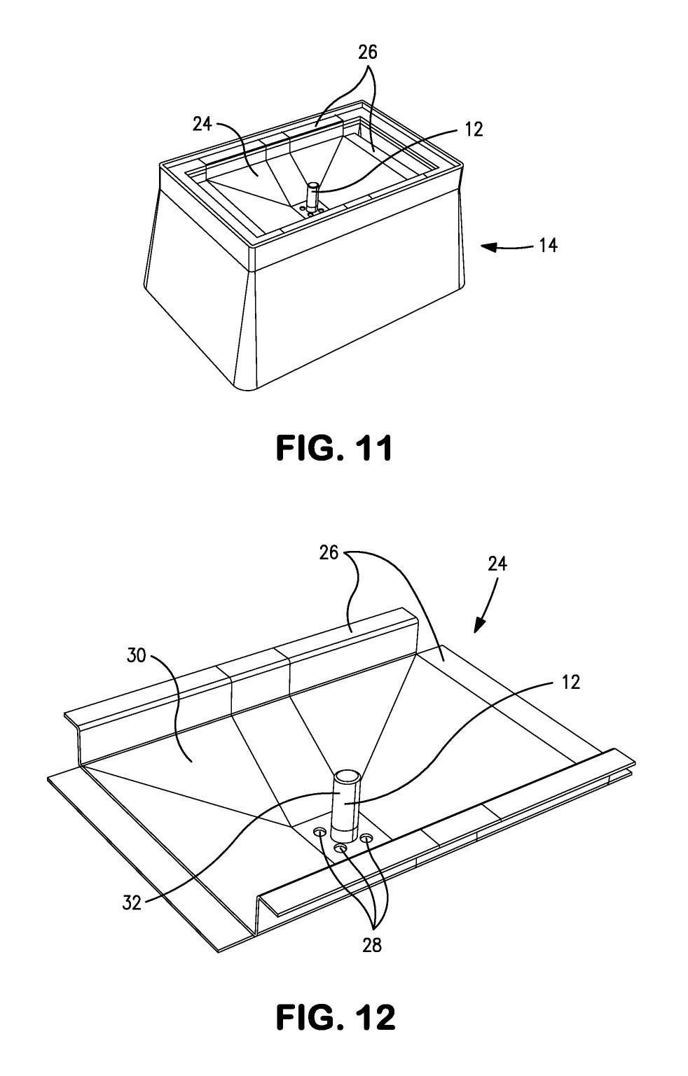

Referring to FIG. 12, the omni-directional vault antenna 12 is illustrated in greater detail. FIG. 12 shows a single omni antenna 12 in the center area, although for MIMO systems, multiple omni-directional antenna elements would typically be used in this area. Surrounding the omni-directional antenna 12 are drain holes 28 which ensure that water does not pool around the antenna 12 when the vault 14 becomes flooded during rainy periods. The antenna deflector plate 30 slopes upward towards the edges 26 of the vault cover 22 (not shown in FIG. 12). In a preferred embodiment, this deflector plate 30 is made from aluminum sheet metal, substantially 1.5 mm to substantially 4.0 mm thick, but could be formed from any other metal or other radio reflective material, such as steel, metalized plastic, or a wire mesh product in which the mesh holes are small compared to the wavelength of the radio frequency signals being transmitted. While the bracket 24, edge 26, and plate 30 are shown as comprising one integral piece of metal, embodiments are contemplated wherein these pieces are separate and assembled on-site or in a manufacturing or assembly facility.

As shown in FIG. 12, the omni-directional antenna 12 has an integrated plastic radome 32 which acts to protect the antenna element 12 from water ingress for the case where the vault becomes flooded, as vaults occasionally do. Alternatively, a bell jar may be employed with attachment points either to the deflector plate, or to the vault cover. The antenna deflector and bracket combination generally slopes upward and away from the antenna 12 with a largely continuous edge 26 just below the vault cover. The upward slope, combined with the largely continuous edge of the antenna being located at or near the ground level, diffracts the radio waves, causing them to bend towards the ground, thereby resulting in a higher effective antenna gain along the ground.

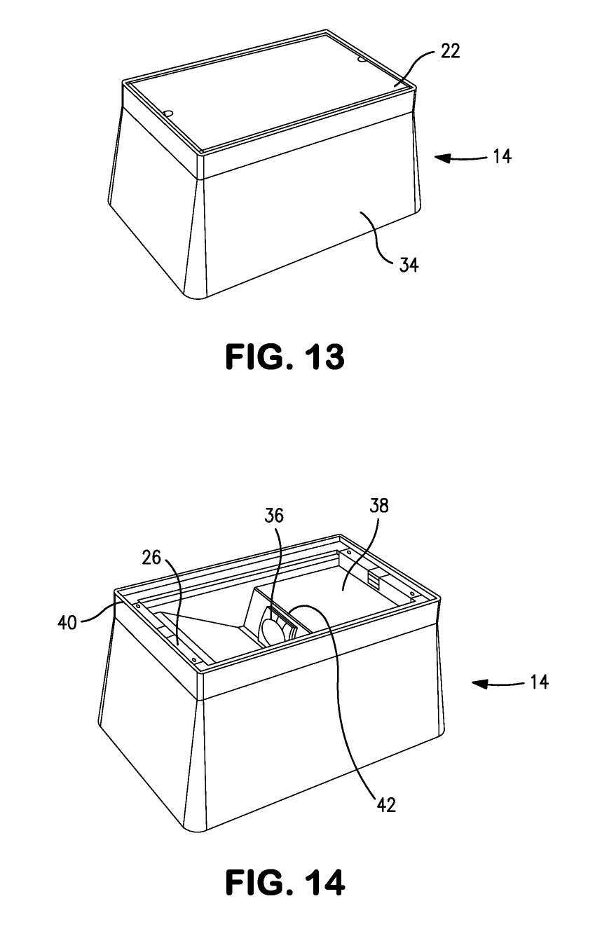

DIRECTIONAL VAULT ANTENNA. A directional vault antenna provides an effective means of directional coverage of a street or open venue. This antenna, located in a substantially ground level vault, includes one or more directional antenna elements mounted in a bracket which slopes upwards to the edge of the vault. Referring to FIG. 13, a vault 14 having a plastic reinforced cover 22 and a plastic base 34 is illustrated. Referring to FIG. 14, the vault 14 of FIG. 13 is shown with the lid or cover 22 removed. The vault antenna structure includes a directional antenna 36 in the middle of the vault, supported by the deflector bracket 38 which slopes upward from the antenna element to guide the antenna signals upward and toward the edge or lip 40 of the vault 14. The fringe effect occurs along the top edge 26 of the metallic bracket 38.

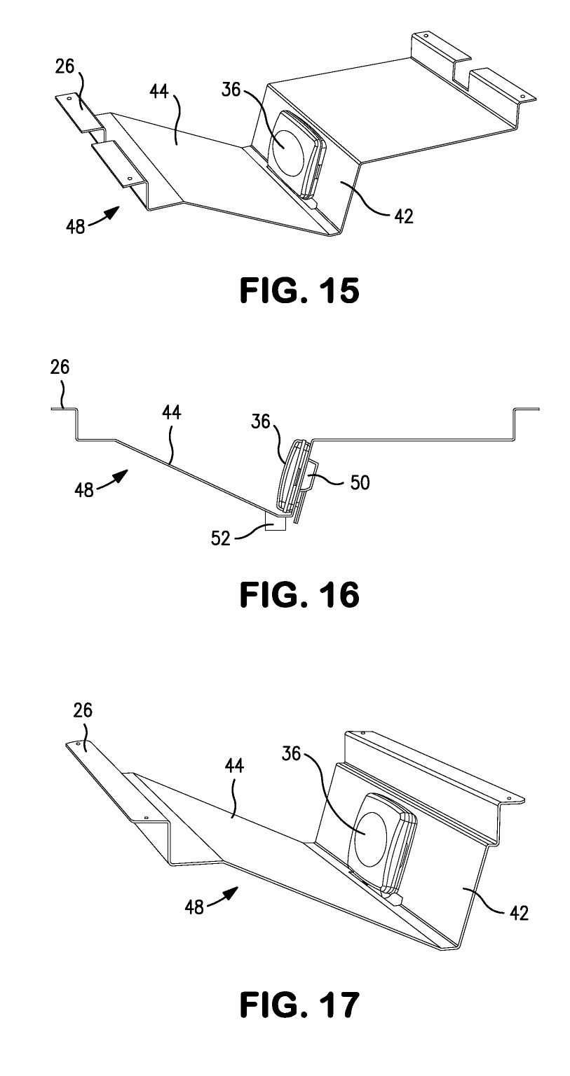

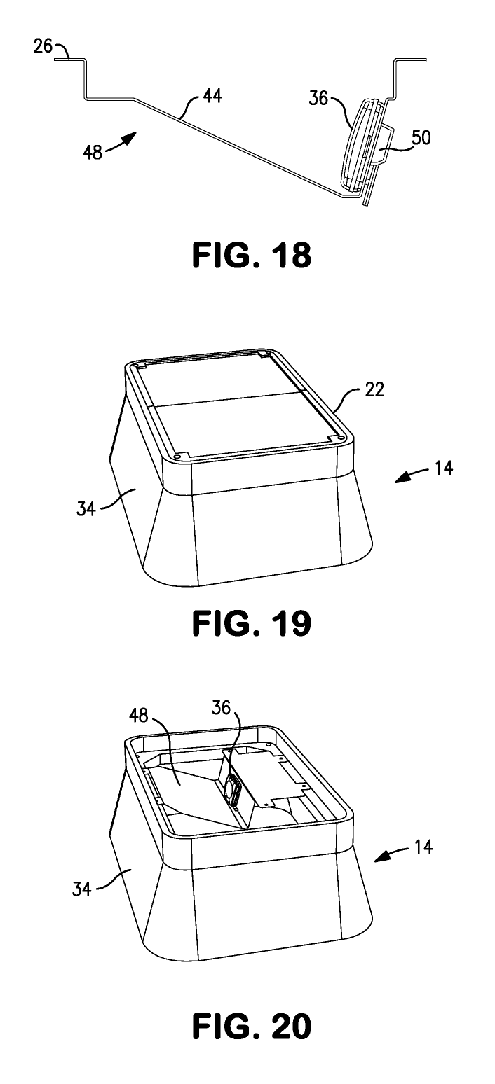

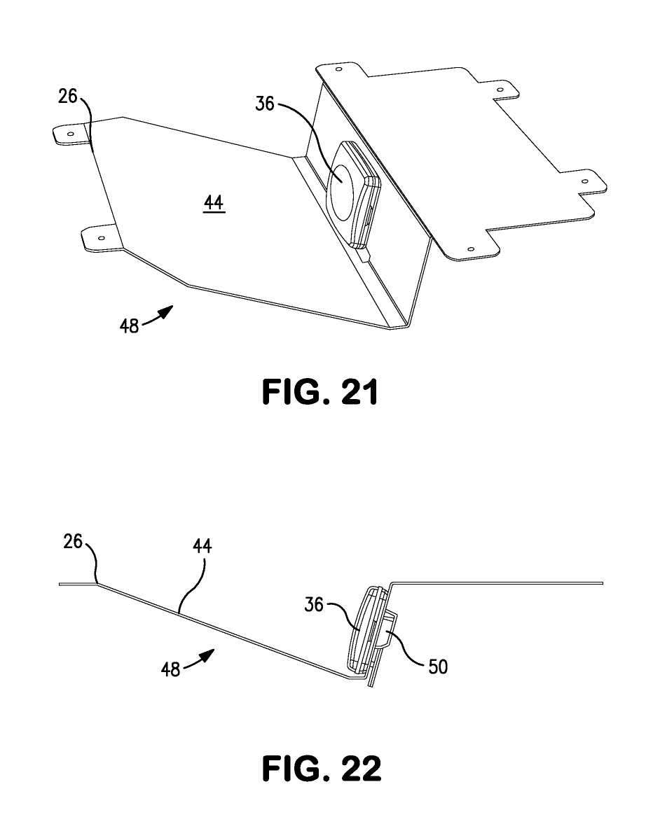

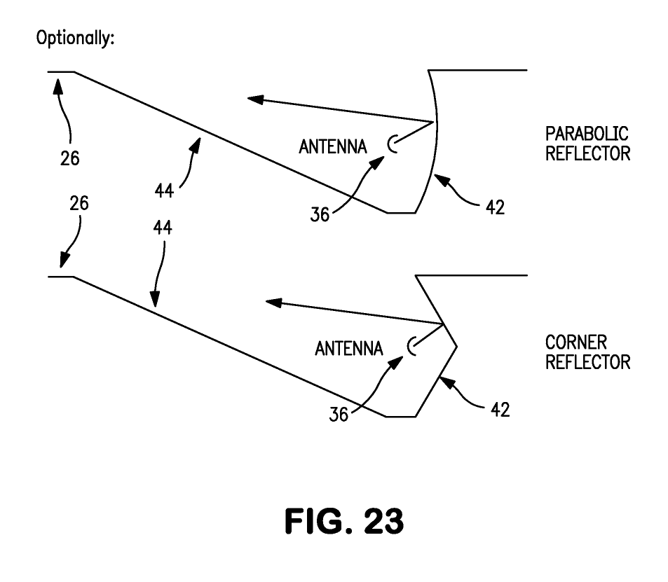

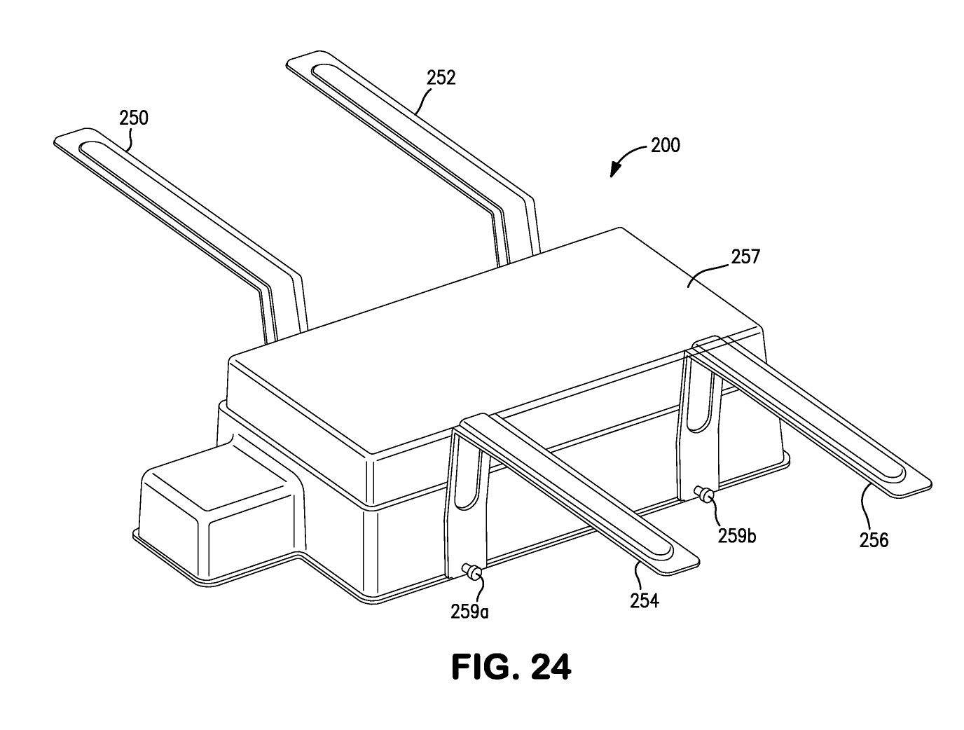

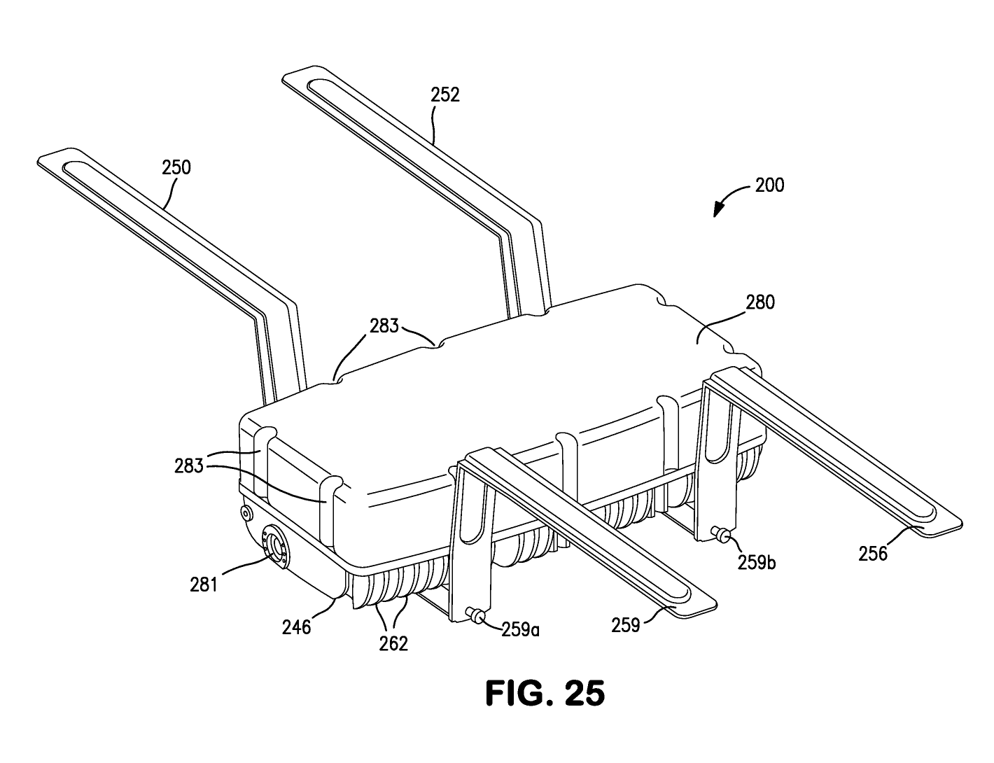

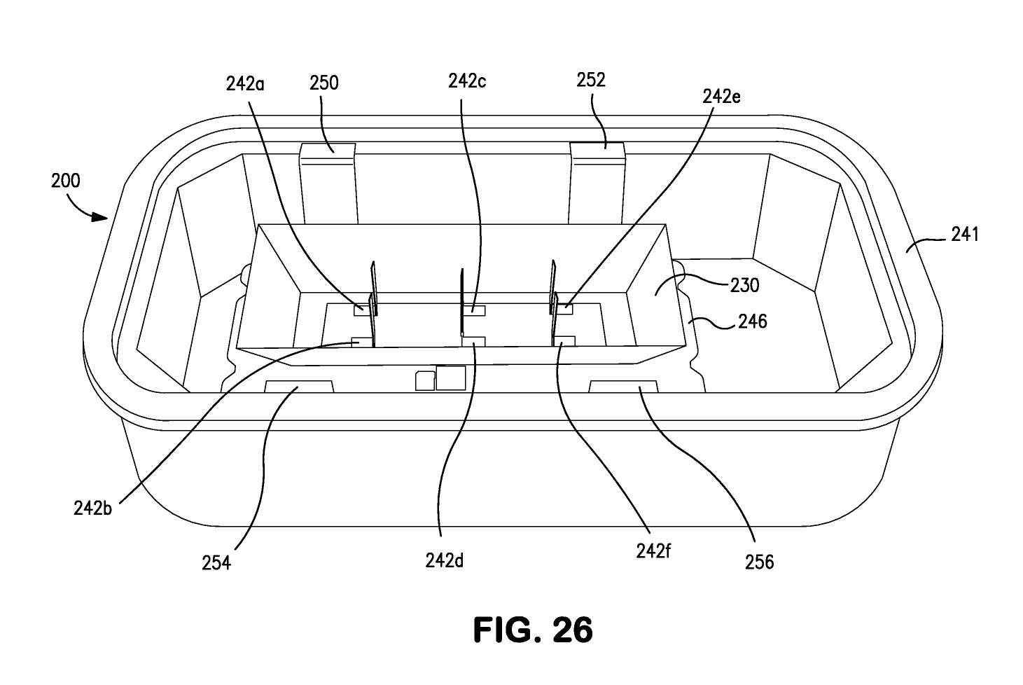

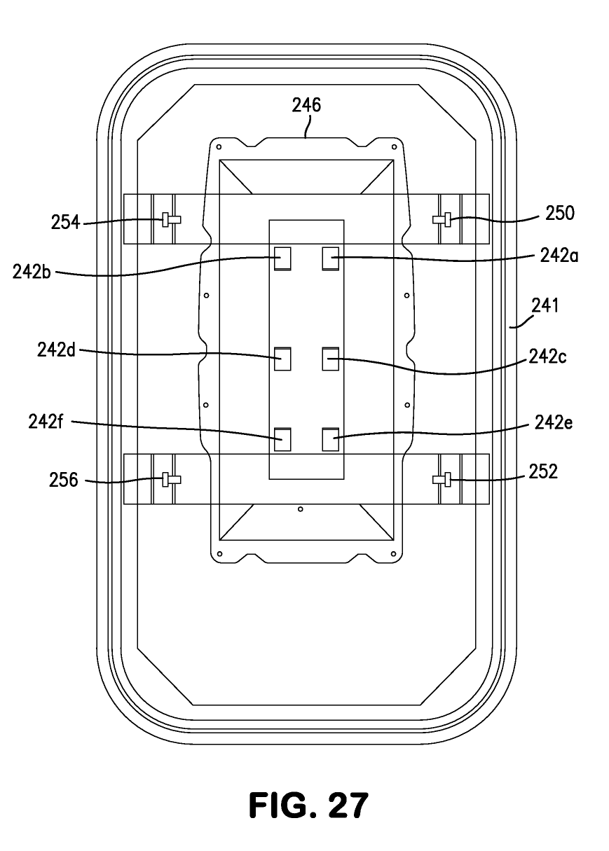

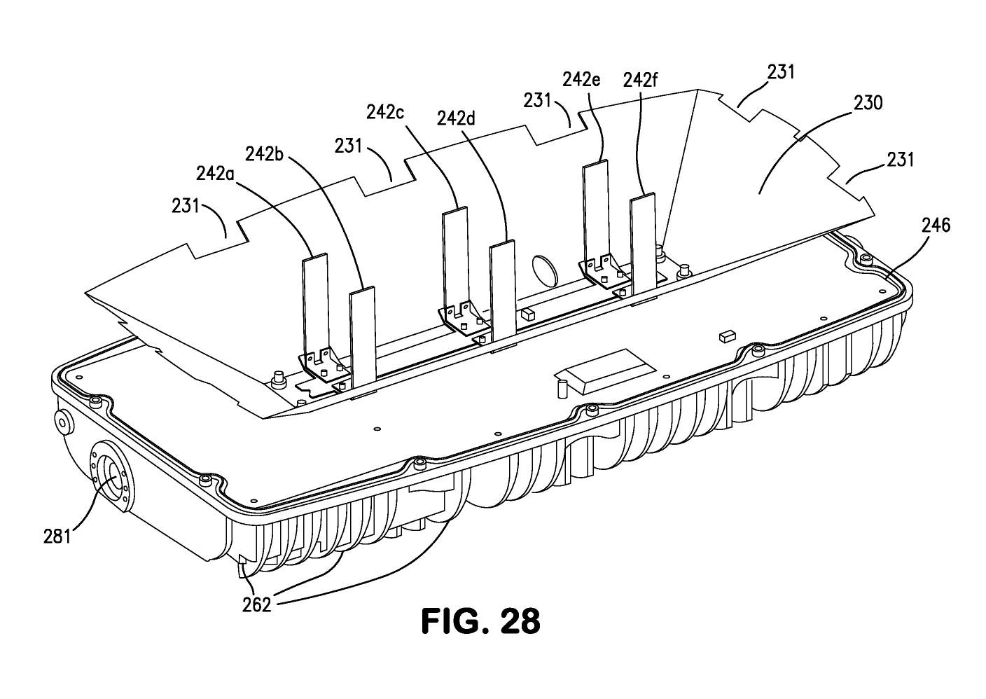

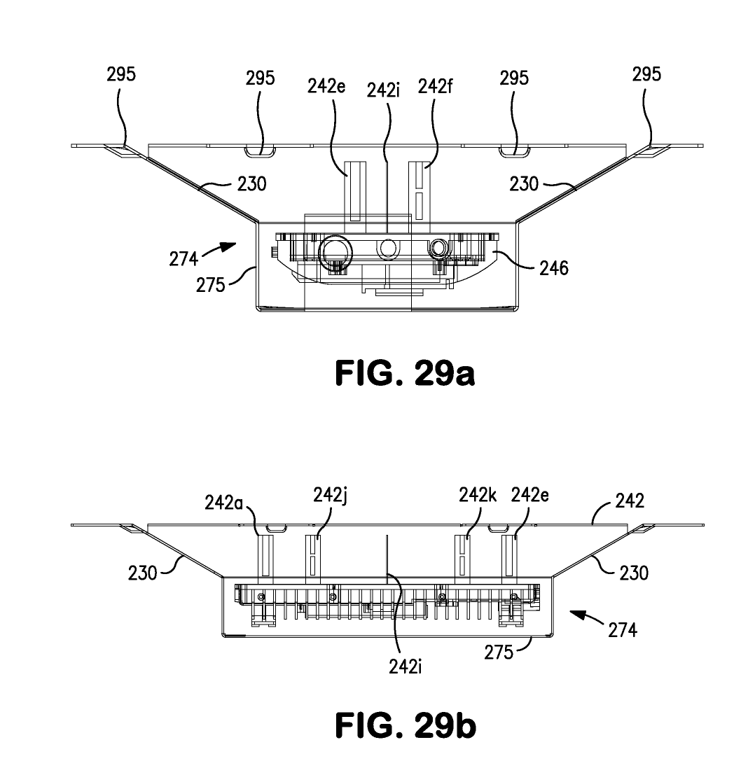

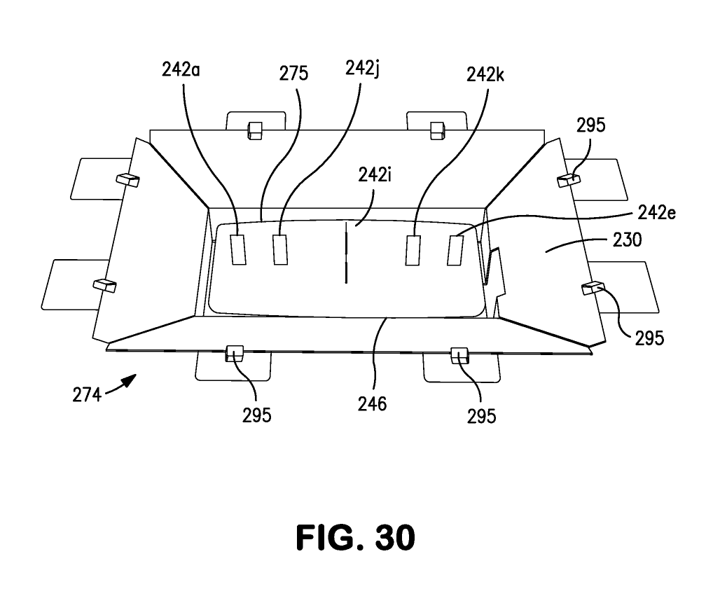

Referring to FIGS. 15-22, perspective and profile views of several commercially available antennas 36 are shown. There are many vault manufacturers, and each has a wide selection of vaults and sizes. The vaults are normally longer than they are wide, and are usually at least partially buried such that the longer dimension aligns with the direction of the street. Two types of directional vault antennas, lengthwise-mount and widthwise-mount, offer flexibility as to the areas that can be targeted by the directional vault antenna, according to the preferred embodiments.

The directional vault antenna preferably includes a single directional antenna 36 in the center area 42, although for MIMO systems, multiple directional antenna elements would typically be used. At the base of the directional antenna are drain holes (not shown in FIGS. 13-22 which ensure that water does not pool around the antenna 36 when the vault becomes flooded during rainy periods. The antenna deflector plate 44 slopes upward towards the desired top edge 26 of the vault. This deflector plate 44 uses radio reflecting materials similar to the omni-directional deflector bracket 24 described above. As with the omni directional vault antenna embodiments, a bell jar may be employed with attachment points either to the deflector plate or to the vault cover to ensure that water does not affect the antenna 36 or associated RF cable (not shown).

The directional antenna deflector bracket 48 generally slopes upward and away from the antenna 36 with a largely continuous edge 26 just below the vault cover. The upward slope, combined with the largely continuous edge of the antenna being located at or near the ground level that diffracts the radio waves causing them to bend towards the ground, resulting in a higher effective antenna gain along the ground. One or more tilt structures 50 may be provided to tilt the antenna 36 (in azimuth and/or elevation) to beam-steer the RF signals as desired. Likewise, an adjusting mechanism 52 may be provided to change the angle, elevation, slope, and/or the position of the plate 44 in order to adjust adjusting or steer the main beam of the antenna 36.

In an alternative embodiment of the present invention, an active high-power vault antenna that does not include a metal edge deflector may be provided. For example, a Wi-Fi™ transceiver that uses a vault antenna may be implemented, provided that sufficient gain can be obtained with a vault antenna that does not include a metal edge diffractor. If the antenna in FIG. 1 is replaced with an active high-power antenna, the gain may be sufficient at all required elevation angles.

In another alternative embodiment of the present invention, an RF transceiver using an antenna according to the description above may be implemented. Such a transceiver may be implemented as a multiband transceiver, a multicarrier transceiver system, or as a multiband, multicarrier transceiver system.

According to a further embodiment, an installation kit or module according to the present invention may be installed in a third-party vault. In FIG. 24, the kit or module 200 includes mounting brackets 250, 252, 254, and 256, which are (preferably) removably affixed to a bell jar covering 257 via structure such as screws 259a and 259b. The bell jar covering 257 is preferably made of plastic or fiberglass and is preferably is sealed to keep the contents water-proof in case of flooding of the below-ground-level vault. The brackets 250, 252, 254, and 256 are configured to be (preferably) removably coupled to an inside of the third-party vault, as will be described in more detail below. The module 200 is preferably compact in size, measuring approximately 6 inches in height.

In FIG. 25, the module 200 is shown with the bell jar covering 257 removed. The mounting brackets 250, 252, 254, and 256 are (preferably) removably coupled to a bottom of an electronics unit support structure 246 (to be described in greater detail blow). A coaxial cable connector 281 is disposed at one end of the support structure 246, and a radome 280 covers the antennas (also to be described below). Detents 283 are provided around the periphery of the radome 280 to accommodate screws which couple the radome to the support structure 246.

As shown in FIG. 26, the module 240 is installed in third-party vault 241 via the mounting brackets 250, 252, 254, and 256 (which may comprise one, two, three, four, or more bracket pieces). These brackets may be made of metal and/or plastic, and may be affixed to the vault 244 via screws, bolts/nuts, interference-fit, tongue-in-slots, etc. Affixed to the brackets is the electronics unit support structure 246, which has antenna elements 242a, 242b, 242c, 242d, 242e, and 242f coupled to a top side thereof. Of course, any number of antenna elements may be used and may be arrayed in a multiple in-line configuration (in two perpendicular directions as shown in FIG. 26), in a single in-line configuration, in a staggered configuration, or in a combined in-line and staggered configuration. The antenna elements may comprise one or more omni-directional antenna elements and/or one or more directional antenna elements. The plural antennas may support a multi-chain (e.g., 3-4 chains) MIMO configuration.

FIG. 26 also shows an antenna deflector plate 230, which may be coupled to the support structure 246 and/or the brackets 250, 252, 254, and/or 256. Like the deflector plate of the earlier-described embodiments, the upper edges of the deflector plate 230 provide a fringe-effect to RF signals communicated to/from the antenna elements 242a, 242b, 242c, 242d, 242e and/or 242f, so as to “bend” the RF signals in a direction more parallel to the ground. The antenna deflector plate 230 shown in FIG. 26 is an upside-down, frusto-rectangular shape having four sloped sides, but may comprise a square, a trapezoid, or any shape useful to provide fringe-effect to the RF signals communicated to/from the antenna elements.

The electronics unit support structure 246 preferably comprises a cast-metal structure configured to contain electronic circuitry such as a transmitter, a receiver, a processor, a memory, a power supply, a cable-connection, etc. For example, the electronics unit support structure 246 may contain circuitry similar to that described in U.S. Pat. Nos. 8,254,865; 8,189,551; 8,009,562; 7,693,105; 7,660,559; and 7,164,667, each of which is incorporated herein by reference. The electronics unit support structure 246 may also include plural cooling fins 262 (FIGS. 26 and 28) configured to carry heat away from the electronic circuitry within the support structure 246.

FIG. 27 is a top view of the FIG. 26 embodiment showing the brackets 250, 252, 254, and 256 connected to the inside surfaces of the vault 241. The brackets 250, 252, 254, and 256 preferably come in different sizes and/or are modifiable so as to mount the module 200 inside a wide variety of third party vaults having different interior dimensions, and many of which contain other electronics modules. The support structure 246 is shown to have an irregular outline, but any convenient shape may be used. In this embodiment, the metal deflector plate 230 (FIG. 28) has a slightly smaller outline than the support element 246, and encloses the antenna elements 242a, 242b, 242c, 242d, 242e, and 242f. In a further variant, it is possible to mount the module 200 to the vault lid rather than the vault walls.

FIG. 28 shows perspective view of a further variant of the FIG. 26 embodiment. In FIG. 28, the deflector plate 230 has plural peripheral cut-outs 231, which are adapted to fit the detents 283 in the radome 280, as shown in FIG. 25.

FIGS. 29a and 29b are, respectively, end and side views of a further embodiment according to the present invention. The support element 246 is mounted inside an enclosure 274, which includes a box-shaped bottom portion 275 and the deflector 230 (which are, preferably, integral). Antenna elements 242a, 242f, and 242e are shown, while further (optional) antenna elements 242i, 242j, and 242k are also shown. Preferably, the top of the enclosure 274 is substantially adjacent to ground level, as discussed above. The bent-angled portions 295 are differently-angled portions of the periphery of the upper edge of deflector plate 230, which are added for structural rigidity at the peripheral edge.

FIG. 30 is a perspective view of the FIGS. 29a and 29b embodiment. The enclosure 274 holds the support element 246 and has the deflector 230 extending up and away from the box-shaped bottom portion 275. The bent-angled portions 295 are shown at two places on each of the four top sides of the deflector 230. Of course more or fewer than two bent-angled portions per side could be used.

While the foregoing detailed description has described particular preferred embodiments of this invention, it is to be understood that the above description is illustrative only and not limiting of the disclosed invention. While preferred embodiments of the present invention have been shown and described herein, it will be obvious to those skilled in the art that such embodiments are provided by way of example only. Numerous variations, changes, and substitutions will now occur to those skilled in the art without departing from the invention.

What is claimed is:

1. A fringe-effect antenna module, comprising:
coupling structure configured to couple the module to a communications vault disposed substantially at ground level;
a support structure coupled to the coupling structure;
at least one antenna element coupled to the support structure; and
a metallic deflector coupled to at least one of (i) the coupling structure and (ii) the support structure, the metallic deflector having an edge, the edge being positioned substantially parallel to the ground, the metallic deflector and the edge being configured to cause a fringe effect upon the RF signals of the antenna to cause said RF signals to bend in a direction toward the ground.

2. The fringe-effect antenna module of claim 1, wherein the at least one antenna element is configured to be disposed below ground level.

3. The fringe-effect antenna module of claim 1, further comprising a radome disposed above the at least one antenna element.

4. The fringe-effect antenna module of claim 1, wherein the metallic deflector comprises an upside-down, frusto-rectangular shape having four sloped sides.

5. The fringe-effect antenna module of claim 1, wherein the support structure includes electronic circuitry having transmission, reception, processing, memory, and power supply functionality.

6. The fringe-effect antenna module of claim 5, wherein the support structure includes at least one cable connector.

7. The fringe-effect antenna module of claim 1, wherein the at least one antenna element is selected from the group consisting of an omni-directional antenna, a directional antenna, a parabolic antenna, and a corner reflecting antenna.

8. A vault antenna module, comprising:
a support structure including electronic circuitry;
coupling structure coupled to the support structure and configured to couple to a substantially ground-level vault;
an antenna element coupled to the support structure;
a deflector plate having at least one edge configured to bend RF signals to/from said antenna element in a direction substantially along the ground; and
a cable connector coupled to the support structure.

9. A vault antenna module according to claim 8, wherein the coupling structure is configured to be coupled to at least two inside walls of the vault.

10. A vault antenna module according to claim 8, wherein the antenna is disposed substantially orthogonal to an upper surface of the support structure.

11. A vault antenna module according to claim 8, further comprising a bell jar covering disposed over the support structure.

12. A vault antenna module according to claim 11, further comprising a radome disposed below the bell jar covering and above the support structure.

13. A system for providing WLAN or cellular radio coverage from a substantially ground-level vault, the system comprising:
the fringe-effect antenna module of claim 1;
the vault, coupled to said fringe-effect antenna module; and
at least one wire coupled to said fringe-effect antenna module.

14. The system of claim 13, wherein the at least one wire is configured to carry signals selected from the group consisting of DOCSIS, DSL, ADSL, HDSL, VDSL, EPON, GPON, Optical Ethernet, T1, and E1.

15. The system of claim 13, wherein the at least one antenna element is configured to enable wide-band, multi-carrier operation.

16. The system of claim 13, wherein the support structure includes a plurality of wireless transceivers, and further comprising a plurality of antenna elements, each of the plurality of antenna elements corresponding to a different one of the plurality of wireless transceivers.

17. Fringe-effect RF antenna structure, comprising:
mounting structure configured to be coupled to an inside of a substantially ground-level vault;
support structure coupled to the mounting structure;
an antenna element coupled to the support structure;
a deflector coupled to said mounting structure and having a sloped portion configured to intersect a main beam of said antenna element; and
an edge coupled to a top portion of the deflector and positioned to have a fringe-effect on the RF signal of said antenna element to bend the RF signal in a direction toward the ground.

18. Structure according to claim 17, wherein said deflector and said edge comprise one integral piece.

19. A kit for installing a fringe-effect module in a substantially ground-level vault, comprising;
an electronics unit containing transmitting structure, receiving structure, processing structure, power structure, and a wiring connector;
plural antenna elements coupled to a top side of the electronics unit;
a radome coupled to the electronics unit and configured to cover the plural antenna elements;
mounting structure coupled to the electronics unit and configured to be coupleable to the substantially ground-level vault; and
a deflector disposed above the electronics unit and having an edge configured to bend RF signals of said plural antenna elements in a more horizontal direction.

20. A method of propagating RF signals to/from a substantially ground-level vault having an antenna element below ground level, comprising:
coupling a support structure into the substantially ground-level vault;
disposing a sloped deflector, coupled to the support structure, to intersect a main beam of the antenna element; and
disposing an edge of the deflector to cause a fringe effect on the RF signals of said antenna element to bend the RF signals in a direction toward the ground level.
